(19) United States
(12) Patent Application Publication
(10) Pub. No.: US 2019/0167021 A1
(43) Pub. Date: Jun. 6, 2019

(54) Protective Cake Shield and Candle Support

(71) Applicant: Angela D. Jones, Riverview, FL (US)

(72) Inventor: Angela D. Jones, Riverview, FL (US)

(21) Appl. No.: 16/267,137

(22) Filed: Feb. 4, 2019

Related U.S. Application Data
(63) Continuation-in-part of application No. 14/172,999, filed on Feb. 5, 2014, now abandoned.
(60) Provisional application No. 61/792,014, filed on Mar. 15, 2013.

(51) Int. Cl. A47G 19/26; A47G 19/02; F21V 35/00

(52) U.S. Cl. CPC A47G 19/26; F21W 2121/002; F21V 35/00; A47G 19/02

(57) ABSTRACT

A cake shield for a cake. The cake shield includes a plate and at least one leg attached thereto. The plate can be constructed in various adaptations and includes a number of flexible insertion holes configured to hold candles without compromising the continuity of the plate. The plate may also be configured for attachment to an interchangeable decorative surface having insertion holes. The legs can adjust the height of the cake shield relative to a surface of the cake, which allows for placement of the cake shield on cakes with varying shapes and dimensions, and can also be folded for storage of the cake shield between uses. During use, the cake shield is configured to protect the cake from damage and exposure to germs by an individual using candles as part of a celebratory event.

### CROSS REFERENCE TO RELATED APPLICATIONS

This application claims the benefit of U.S. Non-Provisional application Ser. No. 14/172,999 filed on Feb. 5, 2014 which claims the benefit of U.S. Provisional Application No. 61/792,014 filed on Mar. 15, 2013. The above identified patent applications are herein incorporated by reference in their entirety to provide continuity of disclosure.

### BACKGROUND OF THE INVENTION

The present invention relates to a cake shield. More specifically, the present invention describes a cake shield comprising a plate that is supported by a pair of legs that can be mounted on a top of a cake. The plate may include a number of flexible insertion holes for placing birthday candles thereon. Alternatively, the plate may be adapted for clipping on a decorative top cover that includes a number of flexible insertion holes. The plate provides a barrier that inhibits the direct contact of expelled air and saliva from a user blowing out birthday cake candles, while preserving the celebratory tradition of blowing out a set of cake candles as part of a birthday celebration.

Birthday parties often include a birthday cake with candles placed on top that are blown out by the individual celebrating his or her birthday. The act of blowing out birthday candles requires an individual to forcefully expel air from his or her mouth in order to extinguish the candle flame. The expelling of air allows germs and saliva to make direct contact with the cake, which causes contamination of the cake. As the cake is consumed, the germs and saliva thereon are ingested by others, which can lead to the spreading of bacteria, viruses, and a variety of illnesses.

The present invention relates to a new and improved cake shield. The device comprises a transparent or opaque (e.g., designed or colorfully designed), that may include a number of flexible insertion holes. The insertion holes expand and contract with candle insertion and removal, respectively, for placing and frictionally securing birthday candles thereon. The device further includes legs for adjusting the height of the plate, which allows for placement of the cake shield on cakes with varying shapes and dimensions. During use, the cake shield provides a barrier that inhibits the direct contact of expelled air and saliva with the cake, while preserving the celebratory tradition of blowing out birthday candles. This prevents the spread of germs and lessens the probability that individuals will become ill after eating the cake. The plate also acts as a reservoir to collect melted wax from the candles. This preserves the cake decorations for later consumption. The device can be washed by hand in a sink. The device is also dishwasher safe, such that it can withstand heat and water pressure in a dishwasher.

### SUMMARY OF THE INVENTION

In view of the foregoing disadvantages inherent in the known types of cake shield devices known in the art, the present invention provides a new and improved cake shield, wherein the same can be utilized for providing a barrier that inhibits the direct contact of expelled air and saliva, while preserving the celebratory tradition of blowing out birthday candles.

It is therefore an object of the present invention to provide a new and improved cake shield device that has all of the advantages of the known art and none of the disadvantages.

It is another object of the present invention to provide a cake shield device that has a plate to act as a barrier between a user and a cake surface.

Another object of the present invention to provide a cake shield device that has insertion holes that holds candles in an upright position and acts as a reservoir to collect melted wax from the candles.

Still another object of the present invention is to provide a cake shield device with legs, which allows for placement of the device on cakes of varying shapes and dimensions.

Yet another object of the present invention is to provide a cake shield device with multiple embodiments that can accommodate different styles of cake.

Yet another object of the present invention is to provide a cake shield device configured for use with various decorative covers having insertion holes.

Yet another object of the present invention is to provide a cake shield device with retractable legs that can be folded inwards for storage between uses.

A final object of the present invention is to provide a cake shield device that can be cleaned by hand or by a dishwasher after one or more uses.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of an embodiment of the protective cake shield and candle support.

FIG. 2 is a side view of an embodiment of the protective cake shield and candle support.

FIG. 3A shows a conventional birthday candle being inserted through a flexible material in a candle insertion hole.

FIG. 3B shows a conventional birthday candle being inserted through another embodiment of a flexible material in a candle insertion hole.

FIG. 4 shows a perspective view of an embodiment of the protective cake shield and candle support.

### DETAILED DESCRIPTION OF THE INVENTION

Reference is made herein to the attached drawings. Like reference numerals are used throughout the drawings to depict like or similar elements of the protective cake shield and candle support. The figures are intended for representative purposes only and should not be considered to be limiting in any respect.

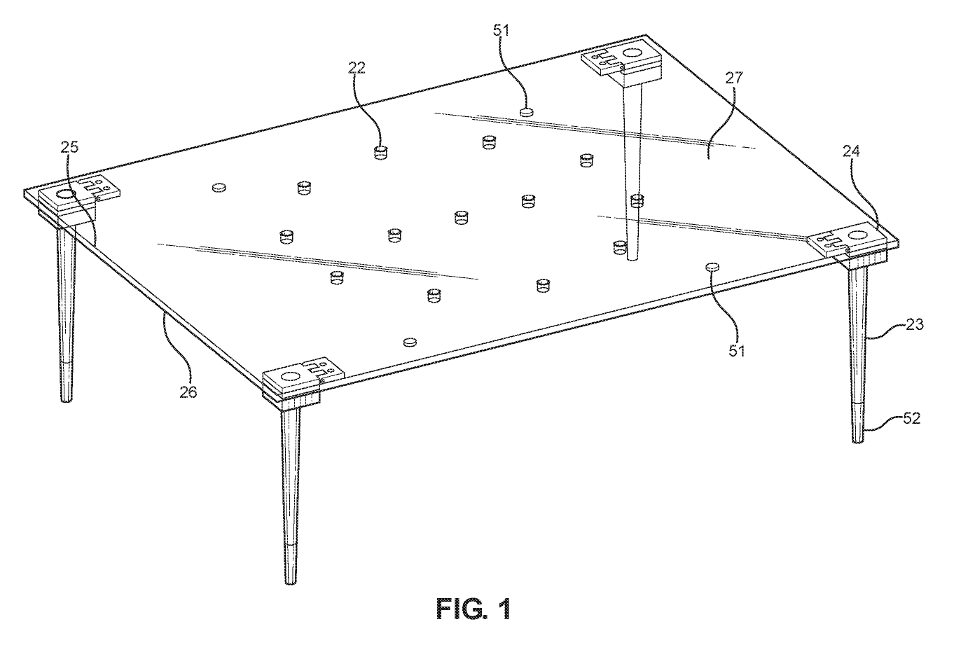

Referring now to FIG. 1, there is shown a perspective view of an embodiment of the cake shield of the present invention. The device comprises a plate 27 for placement above or slightly above a cake surface, and a plurality of legs 23 attached thereto. The plate 27 has a mostly flat upper surface 25 and a mostly flat lower surface 26. The plate 27 is made of a durable material that can withstand heat and water pressure in a dishwasher, for easy cleaning after a use. The plate 27 surface can be formed into any of a variety of shapes and sizes to accommodate cakes of various shapes and dimensions. The plate 27 includes an outer perimeter, wherein the outer perimeter defines an area of protection for the cake provided by the cake shield. In FIG. 1, the plate 27 is rectangular to accommodate a rectangular cake. In an alternate embodiment, the plate 27 is shaped irregularly, e.g., like a football, to accommodate a football themed cake. In a further alternate embodiment, the plate 27 is circular-shaped to accommodate a round cake. The plate 27 surface can be plain, or it can be decorated with any of a plurality of designs or color to accommodate preferences, themes, or styles.

The plate 27 surface has a plurality of circular or rectangular candle insertion holes 22 configured for inserting conventional or ornamental candles therethrough. Each insertion hole 22 comprises a gasket or flaps made of a rubber-like, flexible material along the interior perimeter thereof. The flexible material expands as a candle is inserted therethrough for a snug fit and holds the candle in an upright position. When the candle is removed, the corresponding insertion hole 22 is vacant, the flexible material returns to its original state and the insertion hole 22 is substantially closed. The flexible material prevents saliva or debris from passing through the insertion holes 22 and onto the cake through the vacant holes 22. The secure support of the candles at their base also collects melted wax that trickles downward therefrom, preventing wax from dripping onto the cake surface.

The legs 23 of the cake shield are attached to the lower surface 26 via a plurality of hinges 24. The hinges 24 allow the legs 23 to rotate into a stowed state, such that they can fold in toward the center of the plate 27 and lie parallel to the plate 27 when the cake shield is not in use. The hinges 24 also allows the legs 23 to fold outwards into a working state, whereby the legs 23 extend perpendicularly outward from the plate 27 when the cake shield is in use. The legs 23 may be disposed in an adjacent relationship, or alternately, can be positioned across from one another along the lower surface of the plate 27 for greater stability. In the shown embodiment four legs 23 are shown, however, it is also contemplated that alternate numbers of legs may be deployed on a given plate for support of the plate 27 itself and the candles thereon, including but not limited to one, two, three, four, or more legs 23.

A fastener 51 is disposed on the lower surface 26 of the plate 27. The fastener 51 is configured to secure each leg 23 in the stowed configuration. The fastener 51 allows for each leg to be secured in the stowed configuration so that the protective cake shield of the present invention can be stored in a substantially flat position. In the illustrated embodiment, the fastener 51 comprises a magnet disposed on a lower surface of the plate 27. The magnet is configured to correspond with a magnetic material 52 of the leg 23, such that the leg 23 can be secured in a stowed state by the magnetic interaction between the magnetic material 52 of the leg 23, and the magnet of the fastener 51. In the illustrated embodiment, the magnetic material 52 is disposed on a distal end of the leg 23.

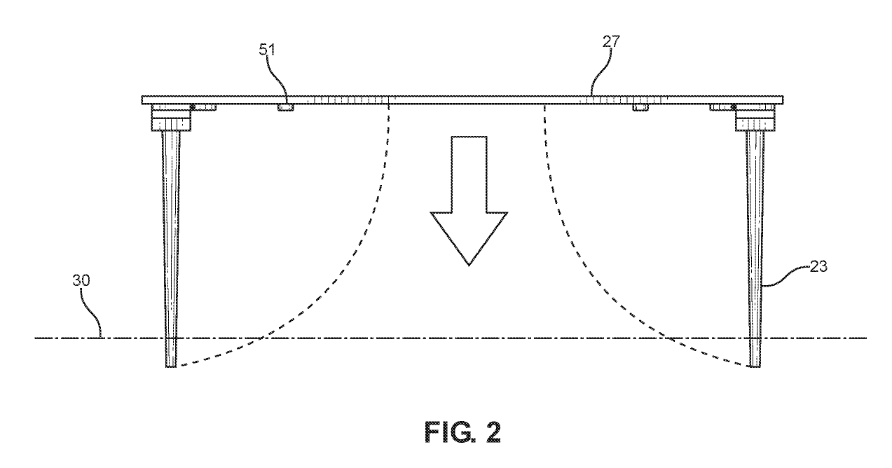

Referring now to FIG. 2, there is shown a side view of the present invention. In operation, a user folds out the legs 23 and places the device onto a surface of a single- or multi-tiered cake. The legs 23 have a pointed tip at the ends thereof, such that the legs 23 are configured to be partially inserted into the cake 30 while the plate surface 27 of the device is elevated slightly above the cake 30.

In the illustrated embodiment, the fastener 51 comprises a latch configured to secure each leg 23 in a stowed configuration. The latch is of any design suitable for frictionally securing the leg 23 therein. In an alternate embodiment, the lower surface of the plate defines a housing corresponding to each leg 23 such that each leg 23 is contained therein when in a stowed state.

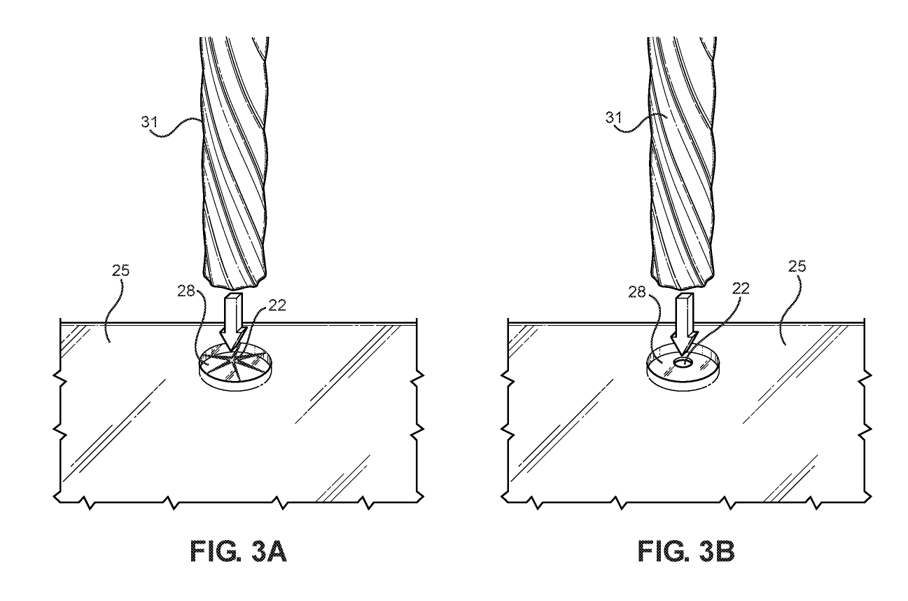

Referring now to FIGS. 3A and 3B, there are shown multiple embodiments of the flexible material within the insertion holes 22 of the present invention. Each insertion hole 22 includes a rubber-like, flexible material 28 around the inner perimeter to support candles of various shapes and sizes in an upright position. The flexible material 28 has the ability to reshape itself after it has been stretched. In FIG. 3A, there is shown a flap-like embodiment of the flexible material 28 around the inside perimeter of the insertion hole 22. The flaps of this embodiment are pushed downwards as a candle 31 is pushed therethrough. When the candle 31 is removed, the flaps are pulled back up to their starting position to keep the insertion hole 22 substantially closed. In FIG. 3B, there is shown an individual gasket-like embodiment of the flexible material 28 that expands when the candle 31 is pressed therethrough. The candle 31 is squeezed through the small aperture in the flexible material 28, which expands when the candle 31 is pressed therethrough. When the candle 31 is removed, the flexible material 28 elastically returns to its original shape to maintain the insertion hole 22 in a substantially closed state.

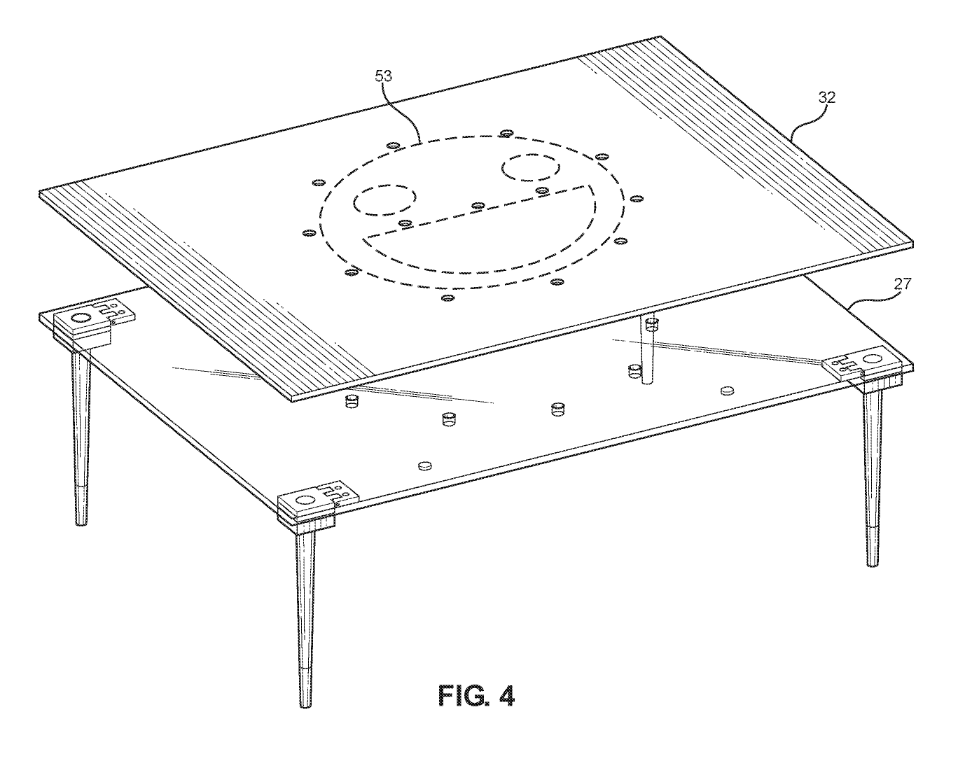

Referring now to FIG. 4, there is shown an embodiment of a decorative cover 32 being attached to the top of the plate 27. To attach the cover 32 to the top of the plate 27, a user slides on the decorative cover 32 to the plate 27 once they are aligned. In an alternate embodiment, a clip secures the decorative cover 32 in place. Aligning the decorative cover 32 and the plate 27 would also align the insertion holes on the decorative cover 32 with a set of insertion holes on the plate 27. The decorative cover 32 is easily interchangeable, allowing the user to attach a different decorative cover 32, e.g., a decorative cover featuring a different design to change the appearance of the device, without obtaining a new cake shield assembly. In one embodiment, the decorative cover 32 is configured to have an image 53 depicted on a top surface of the cover 32. As such, the user is able to personalize the image 53 overlaying the decorative cover 32 according to any design.

The present invention provides a protective cake shield that is designed to provide a protective barrier between a user and a top surface of a cake. The cake shield can be configured to accommodate to various styles, shape, and dimensions of a cake. The device enables the user to place candles of various sizes on top of the shield. Additionally, the user can clip on a decorative cover to further change the appearance of the shield.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cake shield, comprising:
a plate having an upper surface, a lower surface, and an outer perimeter;
at least one candle insertion hole disposed through the plate, wherein each candle insertion hole is configured to support a candle in an upright position;
at least one leg adapted to be inserted into a cake, such that the plate is held in an elevated position above the cake;
wherein each leg is affixed via a hinge to the lower surface of the plate, wherein each leg is movable via the hinge between a stowed configuration and an extended configuration;
wherein the stowed configuration includes each leg in a parallel position relative to the plate;
wherein the extended position includes each leg in a non-parallel position relative to the plate;
at least one fastener disposed on the lower surface of the plate, wherein each fastener is configured to secure a corresponding leg in the stowed configuration.

2) The cake shield of claim 1, wherein a flexible material is disposed in an inner perimeter of each candle insertion hole.

3) The cake shield of claim 2, wherein the flexible material is coextensive with the upper surface of the plate.

4) The cake shield of claim 1, wherein a decorative cover is removably disposed on the upper surface of the plate.

5) The cake shield of claim 4, wherein the decorative cover includes an image on a top surface thereof.

6) The cake shield of claim 1, wherein each fastener comprises a magnetic material;
wherein a distal portion of each leg comprises a magnetic material;
wherein a magnetic attraction between the magnetic material of each fastener and the magnetic material of each distal portion of each leg secures each leg in the stowed configuration.

7) The cake shield of claim 1, wherein the fastener comprises a latch configured to secure each leg in the stowed configuration.

8) The cake shield of claim 1, wherein the bottom surface of the plate defines a housing for each leg, such that when each leg is placed in the stowed configuration, each leg is secured in the housing.

9) The cake shield of claim 1, wherein the outer perimeter is rectangular, wherein each leg is disposed on one of four corners of the outer perimeter.
